(19) United States
(12) Patent Application Publication
(10) Pub. No.: US 2017/0108015 A1
(43) Pub. Date: Apr. 20, 2017

(54) Independent Metering Valves with Flow Sharing

(71) Applicant: Caterpillar Inc., Peoria, IL (US)

(72) Inventor: Andrew J. Kleitsch, Shorewood, IL (US)

(73) Assignee: Caterpillar Inc., Peoria, IL (US)

(21) Appl. No.: 14/918,146

(22) Filed: Oct. 20, 2015

(51) Int. Cl. F15B 13/04; F15B 11/16; F15B 13/044

(52) U.S. Cl. CPC F15B 13/0417; F15B 13/044; F15B 11/163; F15B 2211/3053; F15B 2211/55

(57) ABSTRACT

A hydraulic system includes a source of pressurized fluid, a plurality of fluid actuators, each fluid actuator associated with an implement control system for hydraulically controlling the fluid actuator, and a load sense signal conditioning passageway fluidly connecting each of the implement control systems and configured to facilitate flow sharing between each of the implement control systems. Each of the fluid actuators includes a first chamber and a second chamber, and each of the implement control systems includes: a head-end IM supply valve configured to selectively fluidly connect the source with the first chamber; a rod-end IM supply valve configured to selectively fluidly connect the source with the second chamber; and a load compensating valve configured to control a pressure of a fluid directed between the source and the head-end IM supply and rod-end IM supply valves in response to a load acting on the fluid actuator.

### TECHNICAL FIELD

The present disclosure relates generally to a hydraulic system, and more particularly, to a hydraulic system providing flow sharing between independent metering valves.

### BACKGROUND

Work machines such as, for example, feller bunchers, dozers, loaders, excavators, motor graders, and other types of heavy machinery use one or more hydraulic actuators to accomplish a variety of tasks. These actuators are fluidly connected to a pump on the work machine that provides pressurized fluid to chambers within the actuators. An electro-hydraulic valve arrangement may be fluidly connected between the pump and the actuators to control a flow rate and direction of pressurized fluid to and from the chambers of the actuators. Fluid power may be transferred from one or more hydraulic pumps through fluid conduits to one or more hydraulic actuators. Hydraulic actuators may include hydraulic motors that convert fluid power into shaft rotational power, fluid actuators that convert fluid power into translational power, or other hydraulic actuators known in the art.

Work machine hydraulic circuits that fluidly connect multiple actuators to a common pump may experience undesirable pressure fluctuations within the circuits during operation of the actuators. In particular, the pressure of a fluid supplied to one actuator may undesirably fluctuate in response to operation of a different actuator fluidly connected to the same hydraulic circuit. These pressure fluctuations may cause inconsistent and/or unexpected actuator movements. In addition, the pressure fluctuations may be severe enough and/or occur often enough to cause malfunction or premature failure of hydraulic circuit components. Moreover, in instances where the work machine has actuators that are operated in a complementary fashion, a pressure fluctuation in one of the actuators could adversely affect operability of the work machine if the other actuator does not compensate for that pressure fluctuation. One particular example might be first and second actuators that operate the left and right treads of a work machine, respectively; if a pressure fluctuation occurs in the first actuator as a result of the left tread slipping on rough ground or varied underfoot conditions, and the second actuator controlling the right tread does not adjust in response to the pressure fluctuation, the speed of the treads would be unbalanced, causing the work machine to travel in an undesired direction or at an undesired speed.

U.S. Pat. No. 7,204,084 (hereinafter “the '084 publication”), titled “Hydraulic system having a pressure compensator,” purports to describe a hydraulic system for a work machine that includes a source of pressurized fluid and a fluid actuator with a first chamber and a second chamber. The hydraulic system includes a first valve that fluidly communicates the source of pressurized fluid with the first chamber and a second valve that fluidly communicates the source of pressurized fluid with the second chamber. A proportional pressure compensating valve controls a pressure of a fluid directed between the source and the first and second valves. The '084 publication does not, however, facilitate compensation in instances where the work machine has actuators that are operated in a complementary fashion, and thus a pressure fluctuation in one of the actuators could adversely affect operability of the work machine because the other actuator would not compensate for that pressure fluctuation.

Accordingly, there is a need for improved hydraulic systems to address the problems described above and/or problems posed by other conventional approaches.

### SUMMARY

In one aspect, the disclosure describes a hydraulic system including a source of pressurized fluid, a plurality of fluid actuators, each fluid actuator associated with an implement control system for hydraulically controlling the fluid actuator, and a load sense signal conditioning passageway fluidly connecting each of the implement control systems and configured to facilitate flow sharing between each of the implement control systems. Each of the fluid actuators includes a first chamber and a second chamber, and each of the implement control systems includes: a head-end independent metering (IM) supply valve configured to selectively fluidly connect the source with the first chamber; a rod-end IM supply valve configured to selectively fluidly connect the source with the second chamber; and a load compensating valve configured to control a pressure of a fluid directed between the source and the head-end IM supply and rod-end IM supply valves in response to a load acting on the fluid actuator.

In a further aspect, a machine includes a plurality of work implements and a hydraulic system. The hydraulic system includes: a source of pressurized fluid; a plurality of fluid actuators; a plurality of implement control systems; and a load sense signal conditioning passageway fluidly connecting each implement control system and configured to facilitate flow sharing between each implement control system. Each fluid actuator is associated with a work implement and includes a first chamber and a second chamber. Each implement control system is configured to control one of the fluid actuators and includes: a head-end IM supply valve configured to selectively fluidly connect the source with the first chamber; a rod-end IM supply valve configured to selectively fluidly connect the source with the second chamber; and a load compensating valve configured to control a pressure of a fluid directed between the source and the head-end IM supply and rod-end IM supply valves in response to a load acting on the fluid actuator.

It is to be understood that the disclosure is not limited in its application to the details of construction and to the arrangements of the components set forth in the following description or illustrated in the drawings. The disclosed device and method are capable of aspects in addition to those described and of being practiced and carried out in various ways. Also, it is to be understood that the terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various aspects. It is important, therefore, that the claims be regarded as including such equivalent constructions insofar as they do not depart from the spirit and scope of the various aspects.

### BRIEF DESCRIPTION OF THE DRAWINGS

FIG. 1 is a side-view diagrammatic illustration of a work machine according to an exemplary disclosed embodiment.

FIG. 2 is a schematic illustration of an exemplary disclosed hydraulic circuit.

FIG. 3 is a schematic illustration of another exemplary disclosed hydraulic circuit.

FIG. 4 is a schematic illustration of a further exemplary disclosed hydraulic circuit.

FIG. 5 is a schematic illustration of an exemplary flow control module circuit.

The drawings presented are intended solely for the purpose of illustration and therefore, are neither desired nor intended to limit the subject matter of the disclosure to any or all of the exact details of construction shown, except insofar as they may be deemed essential to the claims.

### DETAILED DESCRIPTION

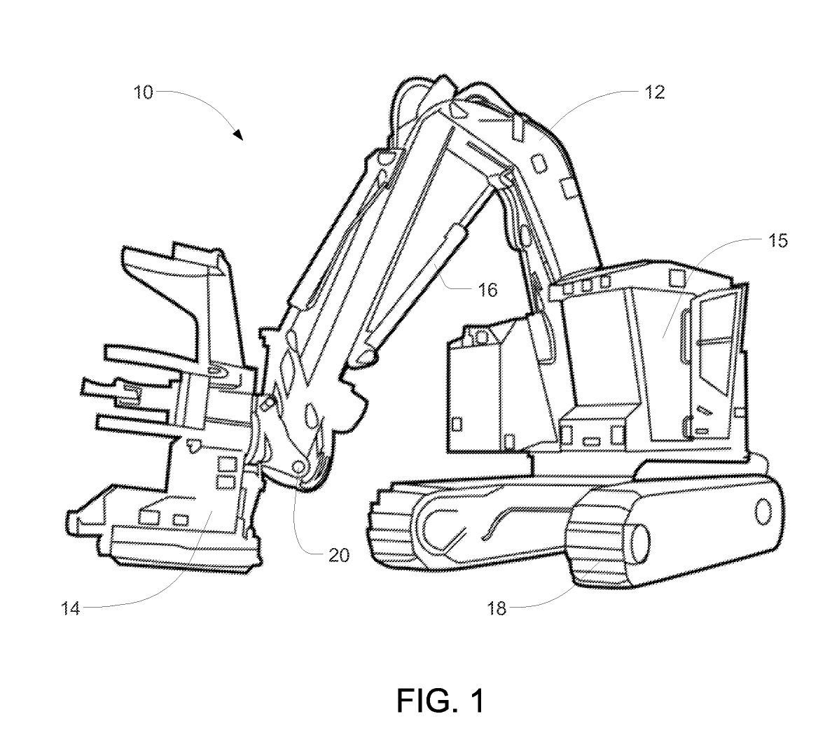

FIG. 1 illustrates an exemplary work machine 10. The work machine 10 may be a fixed or mobile machine that performs some type of operation associated with an industry such as mining, construction, farming, or any other industry known in the art. For example, the work machine 10 may be an earth moving machine such as a feller buncher, a dozer, a loader, a backhoe, an excavator, a motor grader, a dump truck, or any other earth moving machine. The work machine 10 may also include a generator set, a pump, a marine vessel, or any other suitable operation-performing work machine. The work machine 10 may include a frame 12, at least one work implement 14, and at least one fluid actuator 16 connecting the work implement 14 to the frame 12. It is contemplated that the fluid actuator 16 may be omitted, if desired, and a hydraulic motor included. The at least one fluid actuator 16 may, in some aspects, be one or more of a cylinder, a rotary actuator, and a fluid motor.

The frame 12 may include any structural unit that supports movement of the work machine 10. The frame 12 may be, for example, a stationary base frame connecting a power source (not shown) to a traction device 18, a movable frame member of a linkage system, or any other frame known in the art.

The work implement 14 may include any device used in the performance of a task. For example, the work implement 14 may include a saw (e.g., bar saw or disc saw), a harvesting head, a blade, a bucket, a shovel, a ripper, a dump bed, a propelling device, or any other task-performing device known in the art. The work implement 14 may be connected to the frame 12 via a direct pivot 20, via a linkage system with the fluid actuator 16 forming one member in the linkage system, or in any other appropriate manner. The work implement 14 may operate to pivot, rotate, slide, swing, or move relative to the frame 12 in any other manner known in the art.

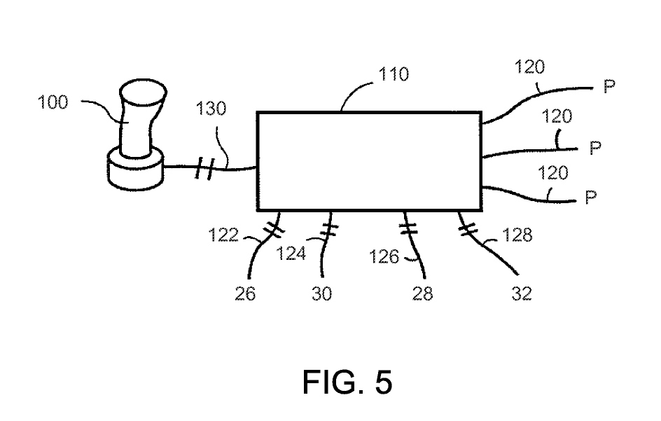

The work machine 10 may also include an operator cab or operator station 15 that may include devices that receive input from an operator indicative of desired maneuvering. Specifically, the operator cab or operator station 15 may include one or more operator interface devices 100 (shown in FIG. 5), for example a joystick, a steering wheel, or a pedal, that are located near an operator seat (not shown). Operator interface devices may initiate movement of the work machine 10, for example travel and/or tool movement, by producing displacement signals that are indicative of desired work machine 10 maneuvering. As an operator moves the operator interface device 100, the operator may affect a corresponding work machine 10 movement in a desired direction, with a desired speed, and/or with a desired force.

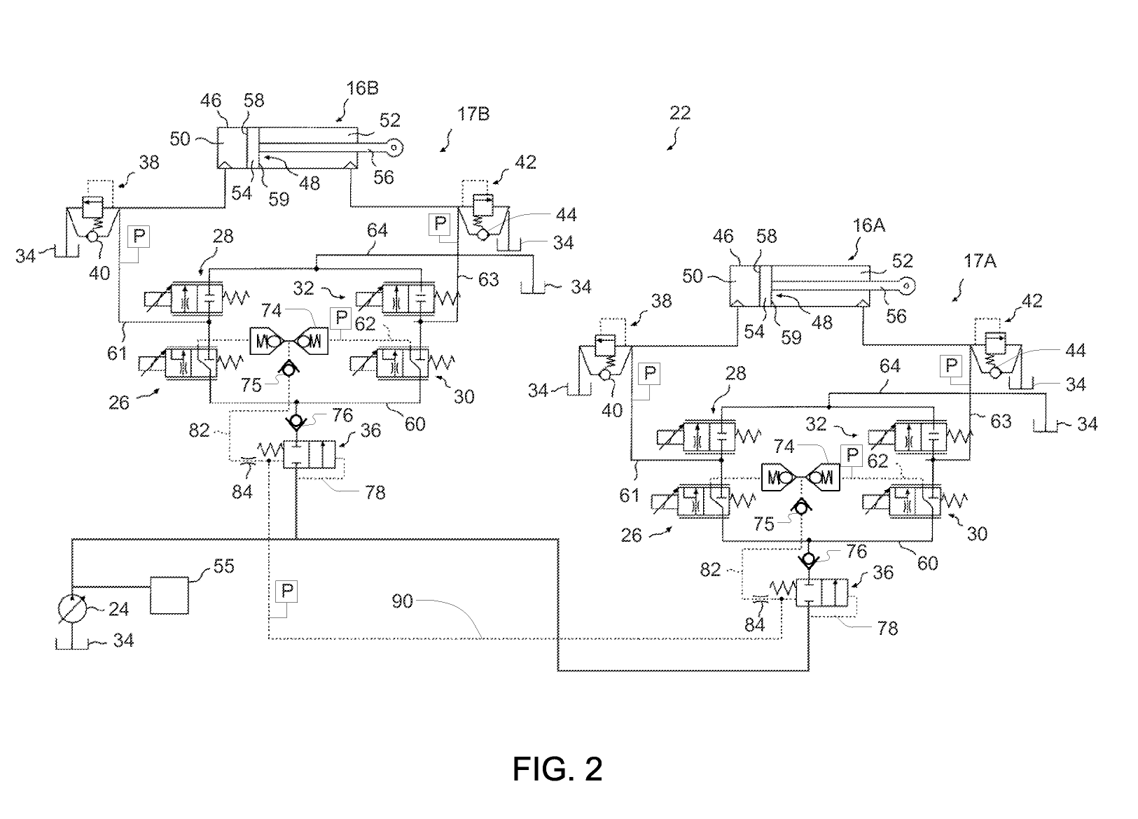

As illustrated in FIG. 2, a hydraulic system 22 includes two fluid actuators 16A and 16B (collectively, the fluid actuators 16), illustrated as hydraulic cylinders. Each of the fluid actuators 16A, 16B is associated with an implement control system 17A and 17B, respectively (collectively, the implement control systems 17), that cooperate to move respective work implements 14. In some aspects the hydraulic system may include more than two fluid actuators 16 and implement control systems 17 cooperating to move the respective work implements 14. The hydraulic system 22 may include a source 24 of pressurized fluid.

The implement control system 17A may include a head-end independent metering (IM) supply valve 26, a head-end IM drain valve 28, a rod-end IM supply valve 30, a rod-end IM drain valve 32, a tank 34, a load compensating valve 36, a head-end pressure relief valve 38, a head-end makeup valve 40, a rod-end pressure relief valve 42, and a rod-end makeup valve 44. It is contemplated that the implement control systems 17A, 17B may independently include additional and/or different components such as, for example, a pressure sensor, a temperature sensor, a position sensor, a controller, an accumulator, and other components known in the art. Each of the implement control systems 17A, 17B may be collectively referred to as an independent metering valve (IMV) control circuit.

The fluid actuator 16A may include a tube 46 and a piston assembly 48 disposed within the tube 46. One of the tube 46 and the piston assembly 48 may be pivotally connected to the frame 12, while the other of the tube 46 and the piston assembly 48 may be pivotally connected to the work implement 14. It is contemplated that the tube 46 and/or the piston assembly 48 may alternately be fixedly connected to either the frame 12 or the work implement 14. The fluid actuator 16A may include a first chamber 50 and a second chamber 52 separated by the piston assembly 48. The first chamber 50 and second chamber 52 may be selectively supplied with a fluid pressurized by the source 24 and fluidly connected with the tank 34 to cause the piston assembly 48 to displace within the tube 46, thereby changing the effective length of the fluid actuator 16A. The expansion and retraction of the fluid actuator 16A may function to assist in moving the work implement 14. If the hydraulic system 22 is configured to operate a traction device (e.g., left and right side treads), each of the implement control systems 17A, 17B may operate a hydraulic motor (not illustrated) rather than a fluid actuator such as that described herein. In a hydraulic motor, fluid flow in one direction urges the hydraulic motor to rotate a shaft in one direction and fluid flow in the other direction urges the motor to rotate in the other direction.

The piston assembly 48 may include a piston 54 axially aligned with and disposed within the tube 46, and a piston rod 56 connectable to one of the frame 12 and the work implement 14 (referring to FIG. 1). The piston 54 may include a first hydraulic surface 58 and a second hydraulic surface 59 opposite the first hydraulic surface 58. An imbalance of force caused by fluid pressure on the first and second hydraulic surfaces 58, 59 may result in movement of the piston assembly 48 within the tube 46. For example, a force on the first hydraulic surface 58 being greater than a force on the second hydraulic surface 59 may cause the piston assembly 48 to displace to increase the effective length of the fluid actuator 16A. Similarly, when a force on the second hydraulic surface 59 is greater than a force on the first hydraulic surface 58, the piston assembly 48 will retract within the tube 46 to decrease the effective length of fluid actuator 16A. A sealing member (not shown), such as an O-ring, may be connected to the piston 54 to restrict a flow of fluid between an internal wall of the tube 46 and an outer cylindrical surface of the piston 54.

The source 24 may operate to produce a flow of pressurized fluid and may include a pump such as, for example, a variable displacement pump, a fixed displacement pump, or any other source of pressurized fluid known in the art. The source 24 may be drivably connected to a power source (not shown) of the work machine 10 by, for example, a countershaft (not shown), a belt (not shown), an electrical circuit (not shown), or in any other suitable manner. The source 24 may be dedicated to supplying pressurized fluid only to hydraulic system 22, or alternately may supply pressurized fluid to additional hydraulic systems 55 within the work machine 10.

The head-end IM supply valve 26 may be disposed between the source 24 and the first chamber 50 and operable to regulate a flow of pressurized fluid to the first chamber 50. Specifically, the head-end IM supply valve 26 may include a two-position spring biased valve mechanism that is solenoid actuated and which operates to move between a first position at which fluid is allowed to flow into the first chamber 50 and a second position at which fluid flow is blocked from the first chamber 50. It is contemplated that the head-end IM supply valve 26 may include additional or different mechanisms such as, for example, a proportional valve element or any other valve mechanisms known in the art. It is also contemplated that the head-end IM supply valve 26 may alternately be hydraulically actuated, mechanically actuated, pneumatically actuated, or actuated in any other suitable manner. It is further contemplated that the head-end IM supply valve 26 may operate to allow fluid from the first chamber 50 to flow through the head-end IM supply valve 26 during a regeneration event when a pressure within the first chamber 50 exceeds a pressure directed to the head-end IM supply valve 26 from the source 24.

The head-end IM drain valve 28 may be disposed between the first chamber 50 and the tank 34 and operable to regulate a flow of pressurized fluid from the first chamber 50 to the tank 34. Specifically, the head-end IM drain valve 28 may include a two-position spring biased valve mechanism that is solenoid actuated and operable to move between a first position at which fluid is allowed to flow from the first chamber 50 and a second position at which fluid is blocked from flowing from the first chamber 50. It is contemplated that the head-end IM drain valve 28 may include additional or different valve mechanisms such as, for example, a proportional valve element or any other valve mechanism known in the art. It is also contemplated that the head-end IM drain valve 28 may alternately be hydraulically actuated, mechanically actuated, pneumatically actuated, or actuated in any other suitable manner.

The rod-end IM supply valve 30 may be disposed between the source 24 and the second chamber 52 and operable to regulate a flow of pressurized fluid to the second chamber 52. Specifically, the rod-end IM supply valve 30 may include a two-position spring biased valve mechanism that is solenoid actuated and operable to move between a first position at which fluid is allowed to flow into the second chamber 52 and a second position at which fluid is blocked from the second chamber 52. It is contemplated that rod-end IM supply valve 30 may include additional or different valve mechanisms such as, for example, a proportional valve element or any other valve mechanism known in the art. It is also contemplated that the rod-end IM supply valve 30 may alternately be hydraulically actuated, mechanically actuated, pneumatically actuated, or actuated in any other suitable manner. It is further contemplated that the rod-end IM supply valve 30 may operate to allow fluid from the second chamber 52 to flow through the rod-end IM supply valve 30 during a regeneration event when a pressure within the second chamber 52 exceeds a pressure directed to the rod-end IM supply valve 30 from the source 24.

The rod-end IM drain valve 32 may be disposed between the second chamber 52 and the tank 34 and operable to regulate a flow of pressurized fluid from the second chamber 52 to the tank 34. Specifically, rod-end IM drain valve 32 may include a two-position spring biased valve mechanism that is solenoid actuated and operable to move between a first position at which fluid is allowed to flow from the second chamber 52 and a second position at which fluid is blocked from flowing from the second chamber 52. It is contemplated that rod-end IM drain valve 32 may include additional or different valve mechanisms such as, for example, a proportional valve element or any other valve mechanism known in the art. It is also contemplated that rod-end IM drain valve 32 may alternately be hydraulically actuated, mechanically actuated, pneumatically actuated, or actuated in any other suitable manner.

The head-end IM supply valve 26, the rod-end IM supply valve 30, the head-end IM drain valve 28 and the and rod-end IM drain valve 32 may be fluidly connected. In particular, the head-end IM supply valve 26 and rod-end IM supply valve 30 may be connected in parallel to an upstream common fluid passageway 60 and connected to a downstream common fluid passageway 62. As used herein, upstream refers to the side of valve(s) closer to or proximate the source 24 of pressurized fluid, and downstream refers to the side of the valve(s) farther away from or distal the source 24 of pressurized fluid. The head-end IM drain valve 28 and rod-end IM drain valve 32 may be connected in parallel to a common drain passageway 64. The head-end IM supply valve 26 and head-end IM drain valve 28 may be connected in parallel to a first chamber fluid passageway 61. The rod-end IM supply valve 30 and rod-end IM drain valve 32 may be connected in parallel to a common second chamber fluid passageway 63.

The head-end pressure relief valve 38 may be fluidly connected to the first chamber fluid passageway 61 between the first chamber 50 and the head-end IM supply valve 26 and head-end IM drain valve 28. The head-end pressure relief valve 38 may have a valve element spring biased toward a valve opening position and movable to a valve closing position in response to a pressure within the first chamber fluid passageway 61 being above a predetermined pressure. In this manner, the head-end pressure relief valve 38 may operate to reduce a pressure spike within the implement control system 17A caused by external forces acting on the work implement 14 and the piston 54 by allowing fluid from the first chamber 50 to drain to the tank 34.

The head-end makeup valve 40 may be fluidly connected to the first chamber fluid passageway 61 between the first chamber 50 and the head-end IM supply valve 26 and head-end IM drain valve 28. The head-end makeup valve 40 may have a valve element operable to allow fluid from the tank 34 into the first chamber fluid passageway 61 in response to a fluid pressure within the first chamber fluid passageway 61 being below a pressure of the fluid within the tank 34. In this manner, the head-end makeup valve 40 may operate to reduce a drop in pressure within the implement control system 17A caused by external forces acting on the work implement 14 and the piston 54 by allowing fluid from the tank 34 to fill the first chamber 50.

The rod-end pressure relief valve 42 may be fluidly connected to the second chamber fluid passageway 63 between the second chamber 52 and the rod-end IM supply valve 30 and rod-end IM drain valve 32. The rod-end pressure relief valve 42 may have a valve element spring biased toward a valve opening position and movable to a valve closing position in response to a pressure within the second chamber fluid passageway 63 being above a predetermined pressure. In this manner, the rod-end pressure relief valve 42 may operate to reduce a pressure spike within the implement control system 17A caused by external forces acting on the work implement 14 and the piston 54 by allowing fluid from the second chamber 52 to drain to the tank 34.

The rod-end makeup valve 44 may be fluidly connected to the second chamber fluid passageway 63 between the second chamber 52 and the rod-end IM supply valve 30 and rod-end IM drain valve 32. The rod-end makeup valve 44 may have a valve element operable to allow fluid from the tank 34 into the second chamber fluid passageway 63 in response to a fluid pressure within the second chamber fluid passageway 63 being below a pressure of the fluid within the tank 34. In this manner, the rod-end makeup valve 44 may operate to reduce a drop in pressure within the implement control system 17A caused by external forces acting on the work implement 14 and the piston 54 by allowing fluid from the tank 34 to fill the second chamber 52.

The implement control system 17A includes additional components to control fluid pressures and/or flows within the hydraulic system 22. Specifically, in one aspect, each of the implement control systems 17A, 17B includes an inverse resolver valve 74 that is disposed within the downstream common fluid passageway 62. The inverse resolver valve 74 may operate to fluidly connect, via a downstream biasing conduit 82, one of the head-end IM supply valve 26 and rod-end IM supply valve 30 having a lower fluid pressure to the load compensating valve 36 in response to a higher fluid pressure from either the head-end IM supply valve 26 or rod-end IM supply valve 30. In this manner, the inverse resolver valve 74 may resolve pressure signals from the head-end IM supply valve 26 and rod-end IM supply valve 30 to allow the lower outlet pressure of the two valves to affect movement of the load compensating valve 36. Because the inverse resolver valve 74 allows the lower pressure to affect the load compensating valve 36 in response to the higher pressure, the load compensating valve 36 may function correctly even during regeneration events. Further, in combination with a load sense signal conditioning passageway 90 that is fluidly connected to the downstream biasing conduit 82 of each of the implement control systems 17A, 17B, the inverse resolver valve 74 also resolves pressure signals from the head-end IM supply valve 26 and rod-end IM supply valve 30 of one of the implement control systems (e.g., 17A) to allow the lower outlet pressure of the two valves to affect movement of the load compensating valve 36 of the other of the implement control systems (e.g., 17B). In this manner, the load sense signal conditioning passageway 90 connects each of the implement control systems and provides for flow sharing between each of the implement control systems 17A, 17B.

The implement control system 17A may also include a check valve 76 disposed between the load compensating valve 36 and the upstream common fluid passageway 60. It is contemplated that the implement control system 17A may include additional and/or different components to control fluid pressures and/or flows within the implement control system 17A.

The tank 34 may constitute a reservoir operable to hold a supply of fluid. The fluid may include, for example, a dedicated hydraulic oil, an engine lubrication oil, a transmission lubrication oil, or any other fluid known in the art. One or more hydraulic systems within the work machine 10 may draw fluid from and return fluid to the tank 34. It is also contemplated that the hydraulic system 22 and/or each of the implement control systems 17A, 17B may be connected to multiple separate fluid tanks

The load compensating valve 36 may be a hydro-mechanically actuated proportional control valve disposed between the upstream common fluid passageway 60 and the source 24, and may operate to control a pressure of the fluid supplied to the upstream common fluid passageway 60. Specifically, the load compensating valve 36 may include a valve element that is spring biased and hydraulically biased toward a flow blocking position and movable by hydraulic pressure toward a flow passing position. In one aspect, the load compensating valve 36 may be movable toward the flow passing position by a fluid directed via an upstream biasing conduit 78 from a point between the load compensating valve 36 and the source 24 of pressurized fluid. A check valve and/or restrictive orifice (not illustrated) may be disposed within the upstream biasing conduit 78 to minimize pressure and/or flow oscillations within the upstream biasing conduit 78. The load compensating valve 36 may be movable toward the flow blocking position by a fluid directed via the downstream biasing conduit 82 from the inverse resolver valve 74. A check valve 75 may be disposed within the downstream biasing conduit 82 to prevent backpressure from the downstream biasing conduit 82 from affecting the inverse resolver valve, and a restrictive orifice 84 may be disposed within the downstream biasing conduit 82 to minimize pressure and/or flow oscillations within the downstream biasing conduit 82. It is contemplated that the valve element of the load compensating valve 36 may alternately be spring biased toward a flow passing position, that the fluid from the downstream biasing conduit 82 may alternately bias the valve element of the load compensating valve 36 toward the flow passing position, and/or that the fluid from the upstream biasing conduit 78 may alternately move the valve element of the load compensating valve 36 toward the flow blocking position. It is also contemplated that the load compensating valve 36 may alternately be located downstream of head-end IM supply valve 26 and rod-end IM supply valve 30 or in any other suitable location. It is also contemplated that the orifice 84 may be omitted, if desired.

As noted above, the load sense signal conditioning passageway 90 is fluidly connected to the downstream biasing conduit 82 of each of the implement control systems 17A, 17B. As the inverse resolver valve 74 operates to resolve pressure signals from the head-end IM supply valve 26 and rod-end IM supply valve 30 of one of the implement control systems (e.g., 17A) and affect movement of the load compensating valve 36, the load sense signal conditioning passageway 90 translates that pressure signal to the load compensating valve 36 of the other of the implement control systems (e.g., 17B) and affects a movement of that load compensating valve 36. For example, if a pressure change in the head-end IM supply valve 26 and rod-end IM supply valve 30 of one of the implement control systems 17A causes the inverse resolver valve 74 to translate that pressure change to the load compensating valve 36 in that implement control system 17A and close (or partially close) the load compensating valve 36, the load sense signal conditioning passageway 90 translates that pressure change to the load compensating valve 36 in the other implement control system 17B, also biasing closed (or biasing partially closed) the load compensating valve 36 in the other implement control system 17B. In this manner, the load sense signal conditioning passageway 90 connects each of the implement control systems 17A, 17B and provides for flow sharing between each of the implement control systems/IMV control circuits. While the load sense signal conditioning passageway 90 is shown in FIG. 2 as being fluidly connected to the downstream biasing conduit 82 of each of the implement control systems 17A, 17B, the load sense signal conditioning passageway 90 need not be fluidly connected at this location. Purely by way of example, the load sense signal conditioning passageway 90 can be fluidly connected upstream of the orifice 84 (if included) or in another suitable location.

Each of the implement control systems 17A, 17B may further include a flow control module 110 (shown in FIG. 5), such as a microprocessor, which is used to control operation of the implement control system 17A, 17B. The flow control module 110 may be connected by electrical leads 120 to pressure sensors P located throughout the implement control system 17A, 17B. The flow control module 110 is capable of receiving signals from the pressure sensors P over the electrical leads 120 to determine the pressure in various fluid passageways located throughout the hydraulic system 22, including but not limited to the first chamber fluid passageway 61, the second chamber fluid passageway 63, the downstream common fluid passageway 62, and load sense signal conditioning passageway 90.

The head-end IM supply valve 26, the rod-end IM supply valve 30, the head-end IM drain valve 28 and the and rod-end IM drain valve 32 are connected to the flow control module 110 via electrical connections 122, 124, 126 and 128, respectively. The flow control module 110 is capable of sending command signals over the electrical connections 122, 124, 126 and 128 to control operation of the head-end IM supply valve 26, the rod-end IM supply valve 30, the head-end IM drain valve 28 and the and rod-end IM drain valve 32. The flow control module 110 also includes an operator interface device 100 connected to the flow control module 110 by a wire 130. The operator interface device 100 may include such devices as an operator lever, pedal, joystick, keypad, or a keyboard for inputting information such as the speed required of the fluid actuator 16. The operator interface device 100 is also capable of providing an input signal or command to the flow control module 110 over the wire 130. In one aspect the input signal from the operator interface device 100 is a velocity command signal. That is, the operator in the operator station 15 manipulates the operator interface device 100 to achieve a velocity of a selected fraction device 18 or work implement 14.

The flow control module 110 is capable of receiving signals from the operator interface device 100 and pressure sensors P and/or other suitable sensors. Based upon these signals the flow control module 110 is able to control operation of the head-end IM supply valve 26, the rod-end IM supply valve 30, the head-end IM drain valve 28 and the and rod-end IM drain valve 32 and, optionally, the source 24 of pressurized fluid. In some particular examples of control sequences, the head-end IM supply valve 26 and the rod-end IM drain valve 32 may be initially opened and the head-end IM drain valve 28 and the rod-end IM supply valve 30 are initially closed. Extension of the fluid actuator (e.g., 16A) occurs when the head-end IM supply valve 26 and the rod-end IM drain valve 32 are opened and the head-end IM drain valve 28 and the rod-end IM supply valve 30 are closed.

Depending upon the pressures sensed by the pressure sensors P, the rod-end IM supply valve 30 may be opened to restrict the flow of hydraulic fluid, for example, from the fluid actuator (e.g., 16A), to brake or slow down the fluid actuator. Additionally, the head-end IM drain valve 28 may be opened to divert the flow of hydraulic fluid back to the tank 34. The common drain passageway 64 allows hydraulic fluid to flow from the head-end IM drain valve 28 through the common drain passageway 64 into the tank 34 to be used again by the source 24 of pressurized fluid. This provides for a regenerative supply or source of hydraulic fluid for the source of pressurized fluid, and in this mode of operation the implement control system (e.g., 17A) is regenerative. These and other suitable control sequences may be controlled by the flow control module 110.

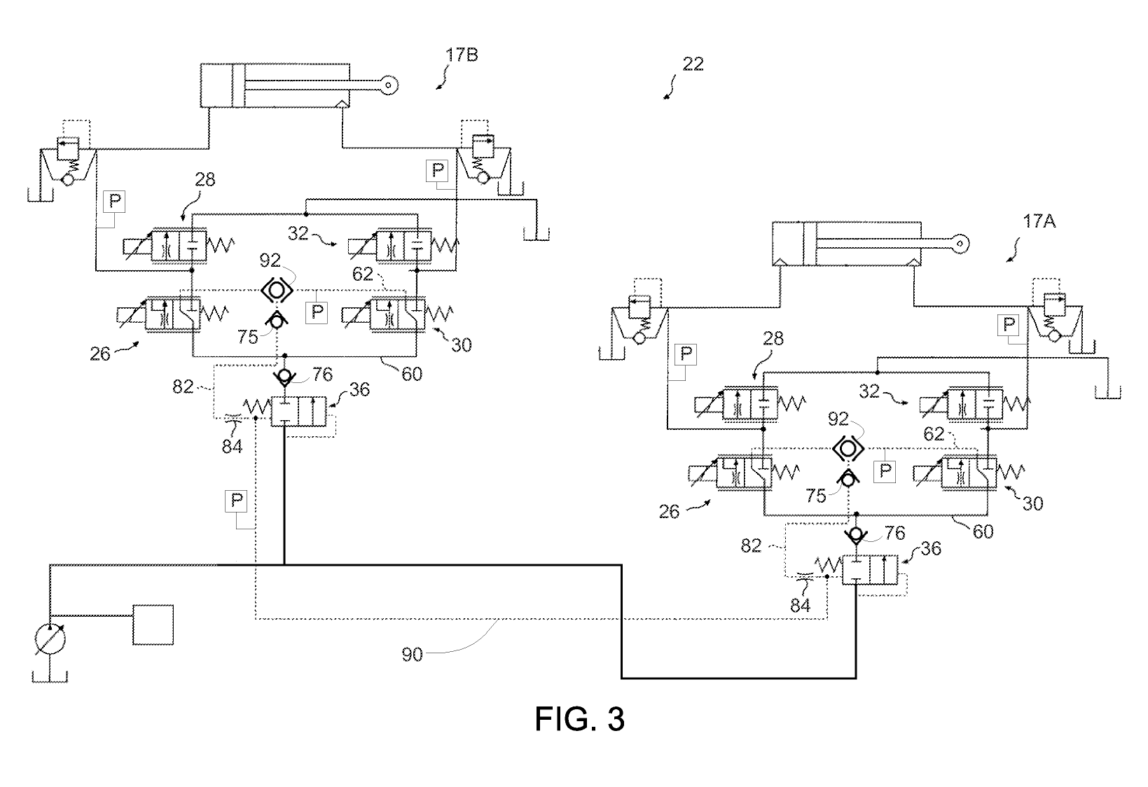

In another aspect illustrated in FIG. 3, each of the implement control systems 17 includes a resolver 92 rather than an inverse resolver valve 74 shown in FIG. 2. The resolver 92 may operate to fluidly connect, via a downstream biasing conduit 82, one of the head-end IM supply valve 26 and rod-end IM supply valve 30 having a higher fluid pressure to the load compensating valve 36 in response to a lower fluid pressure from either the head-end IM supply valve 26 or rod-end IM supply valve 30. In this manner, the resolver 92 may resolve pressure signals from the head-end IM supply valve 26 and rod-end IM supply valve 30 to allow the higher outlet pressure of the two valves to affect movement of the load compensating valve 36. In combination with a load sense signal conditioning passageway 90 that is fluidly connected to the downstream biasing conduit 82 of each of the implement control systems 17A, 17B, the resolver 92 resolves pressure signals from the head-end IM supply valve 26 and rod-end IM supply valve 30 of one of the implement control systems (e.g., 17A) to allow the higher outlet pressure of the two valves to affect movement of the load compensating valve 36 of the other of the implement control systems (e.g., 17B). In this manner, the load sense signal conditioning passageway 90 connects each of the implement control systems and provides for flow sharing between each of the implement control systems/IMV control circuits. The downstream biasing conduit 82 may include a check valve 75 and an orifice 84 as described above. In this aspect, the load sense signal conditioning passageway 90 operates in a similar manner as that illustrated in FIG. 2. As the resolver 92 operates to resolve pressure signals from the head-end IM supply valve 26 and rod-end IM supply valve 30 of one of the implement control systems (e.g., 17A) and affect movement of the load compensating valve 36, the load sense signal conditioning passageway 90 translates that pressure signal to the load compensating valve 36 of the other of the implement control systems (e.g., 17B) and affect a movement of that load compensating valve 36.

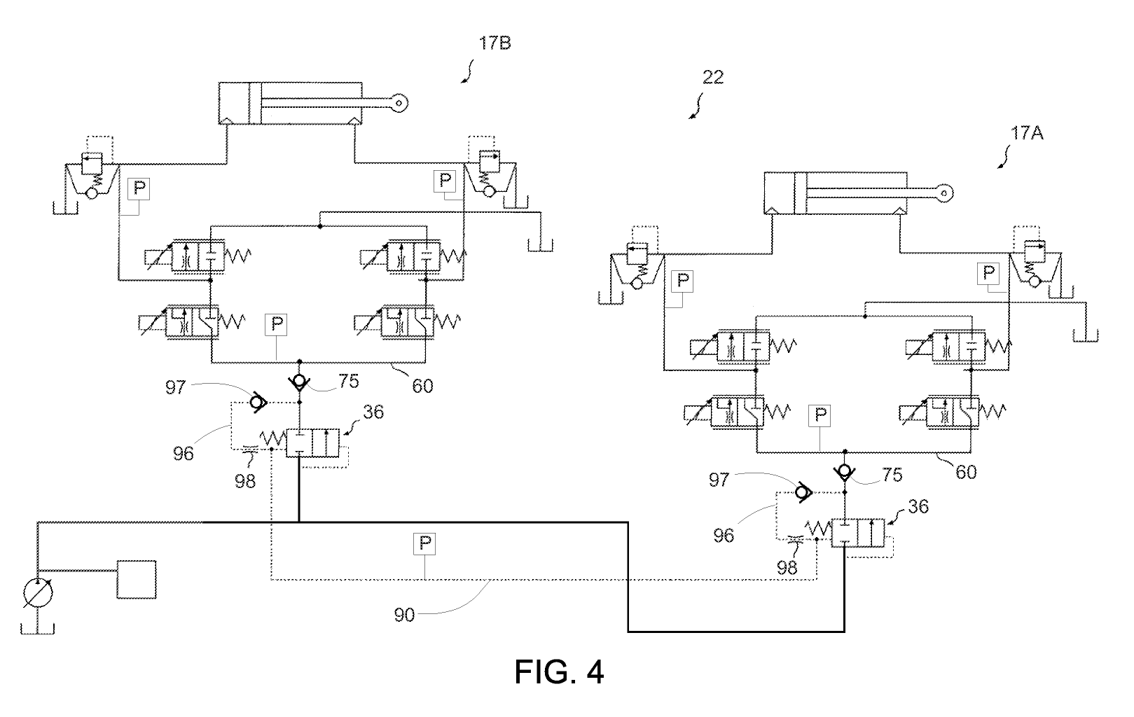

In a further aspect illustrated in FIG. 4, neither of the implement control systems 17 includes an inverse resolver valve or a resolver, and compensation between implement control systems 17 is accomplished by fluidly connecting the load sense signal conditioning passageway 90 to a downstream biasing passageway 96 that is fluidly connected downstream of the load compensating valve 36 of both implement control systems 17A, 17B. The downstream biasing passageway 96 may include a check valve 97 and orifice 98 as illustrated. In this aspect, a pressure change in upstream common fluid passageway 60 will cause a corresponding change in pressure downstream of the load compensating valve 36 and in the downstream biasing passageway 96, which can affect movement of the load compensating valve 36. In addition, the load sense signal conditioning passageway 90 translates the change in pressure in the downstream biasing passageway 96 to the downstream biasing passageway 96 of the other implement control system (e.g., 17B), which can affect a movement of the load compensating valve 36 in the other implement control system. In this manner, the load sense signal conditioning passageway 90 connects each of the implement control systems and provides for flow sharing between each of the implement control systems/IMV control circuits.

While the aspects of the hydraulic system 22 described herein and illustrated in FIGS. 2-4 include two implement control systems 17A, 17B fluidly connected by the load sense signal conditioning passageway 90, it will be recognized that the hydraulic system 22 can include more than two (e.g., three, four or more than four) implement control systems fluidly connected by a common load sense signal conditioning passageway, such that a pressure fluctuation in one of the implement control systems is translated to the implement control systems fluidly connected thereto by the common load sense signal conditioning passageway. In this manner, the load sense signal conditioning passageway 90 connects all of the implement control systems and provides for flow sharing between each of the implement control systems/IMV control circuits.

### INDUSTRIAL APPLICABILITY

The disclosed hydraulic system may be applicable to any work machine that includes a plurality of fluid actuators (e.g., hydraulic cylinders or hydraulic motors) where balancing of pressures and/or flows of fluid supplied to the plurality of actuators is desired. One exemplary aspect of a plurality of actuators (e.g., a plurality of hydraulic motors) would be those connected to left and right side treads of a traction device. In other exemplary aspects, the plurality of actuators may be connected to complementary rollers in a steel mill, or any other system in which flow sharing between the implement control systems/IMV control circuits of a plurality of actuators is desired.

The disclosed hydraulic system may provide high response pressure regulation that protects the components of the hydraulic system and provides consistent actuator performance in a low-cost and simple configuration. The operation of hydraulic system 22 will now be explained.

The plurality of fluid actuators 16A, 16B, each associated with a respective implement control system 17A, 17B, may be independently movable by fluid pressure in response to an operator input. To operate one of the fluid actuators 16A, fluid may be pressurized by the source 24 and directed to the head-end IM supply valve 26 and rod-end IM supply valve 30. In response to an operator input to either extend or retract the piston assembly 48 relative to the tube 46, one of the head-end IM supply valve and rod-end IM supply valve 30 may move to the open position to direct the pressurized fluid to the appropriate one of the first chamber 50 and second chamber 52. Substantially simultaneously, one of the head-end IM drain valve 28 and rod-end IM drain valve 32 may move to the open position to direct fluid from the appropriate one of the first chamber 50 and second chamber 52 to the tank 34 to create a pressure differential across the piston 54 and cause the piston assembly 48 to move. For example, if an extension of the fluid actuator 16A is requested, the head-end IM supply valve 26 may move to the open position to direct pressurized fluid from the source 24 to the first chamber 50 through the load compensating valve 36. Substantially simultaneous to the directing of pressurized fluid to the first chamber 50, the rod-end IM drain valve 32 may move to the open position to allow fluid from the second chamber 52 to drain to the tank 34. If a retraction of the fluid actuator 16 is requested, the rod-end IM supply valve 30 may move to the open position to direct pressurized fluid from the source 24 to the second chamber 52. Substantially simultaneous to the directing of pressurized fluid to second chamber 52, head-end IM drain valve 28 may move to the open position to allow fluid from the first chamber 50 to drain to the tank 34.

Because multiple actuators may be fluidly connected to the source 24, the operation of one of the actuators may affect the pressure and/or flow of fluid directed to the fluid actuator 16A. If left unregulated, these affects could result in inconsistent and/or unexpected motion of the fluid actuator 16A and the traction device 18 or the work implement 14, and could possibly result in shortened component life of the implement control system 17A. The load compensating valve 36 may account for these affects by proportionally moving the valve element of the load compensating valve 36 between the flow blocking and flow passing positions in response to fluid pressures within the implement control system 17A to provide a substantially constant predetermined pressure drop across all supply valves of the implement control system 17A. Further, the load sense signal conditioning passageway 90 translates that pressure change to the load compensating valve 36 in the other implement control system 17B to affect a proportional movement of the valve element of the load compensating valve 36 in the other implement control system. That is, the two load compensating valves 36 work in concert via the pressure control signal provided by the load sense signal conditioning passageway 90 to modulate the flow of fluid provided to the two implement control systems 17A, 17B. In this manner, the load sense signal conditioning passageway 90 connects each of the implement control systems and provides for flow sharing between each of the implement control systems 17A, 17B

As one of the head-end IM supply valve 26 and rod-end IM supply valve 30 are moved to the flow passing position, and the other of the head-end IM supply valve 26 and rod-end IM supply valve 30 is moved to the flow blocking position, pressure within the valve that is in the flow passing position may be lower than the pressure within valve that is in the flow blocking position. As a result, inverse resolver valve 74 may be biased by the lower pressure of the valve in the flow passing position, thereby communicating the lower pressure to the load compensating valve 36. This lower pressure may then act together with the force of the spring of the load compensating valve 36 against the pressure from the upstream biasing conduit 78. The resultant force may then either move the valve element of the load compensating valve 36 toward the flow passing or flow blocking positions. As the pressure from the source 24 drops, the load compensating valve 36 may move toward the flow passing position and thereby maintain the pressure within the upstream common fluid passageway 60. Similarly, as the pressure from the source 24 increases, the load compensating valve 36 may move toward the flow passing position to thereby maintain the pressure within the upstream common fluid passageway 60. In this manner, the load compensating valve 36 may regulate the fluid pressure within the implement control system 17A. Movements of the load compensating valve 36 in the other implement control system 17B would be made due to the load sense signal conditioning passageway 90 that fluidly connects the downstream biasing conduit 82 of each of the implement control systems 17A, 17B.

The load compensating valve 36 may also operate to reduce pressure and/or flow fluctuations within the implement control system 17A caused by the occurrence of regeneration processes within the implement control system 17A. In particular, during movement of the traction device 18 or the work implement 14, there may be instances when an external force on the traction device 18 or the work implement 14 generates a pressure within one of the first chamber 50 and second chamber 52 that is greater than the pressure of the fluid supplied to the head-end IM supply valve 26 or rod-end IM supply valve 30 by the source 24. During these instances, this high pressure fluid may be regenerated to conserve energy. Specifically, this high pressure fluid may be directed from the appropriate one of the first chamber 50 and second chamber 52 to the upstream common fluid passageway 60. The load compensating valve 36 may accommodate this supply of high pressure fluid by moving the valve element of the load compensating valve 36 toward the flow blocking position. In this manner, load compensating valve 36 may provide substantially constant pressure even during regeneration processes. Movements of the load compensating valve 36 in the other implement control system 17B would be made due to the load sense signal conditioning passageway 90 that fluidly connects the downstream biasing conduit 82 of each of the implement control systems 17A, 17B.

Because the load compensating valve 36 is hydro-mechanically actuated, pressure fluctuations within the implement control system 17A may be quickly accommodated before they can significantly influence motion of the fluid actuator 16A or life of components within the implement control system 17A. In particular, the response time of the load compensating valve 36 may be about 200 hz or higher, which is much greater than typical solenoid actuated valves that respond at about 5-15 hz. In addition, because the load compensating valve 36 may be hydro-mechanically actuated rather than electronically controlled, the cost of the implement control system 17A and resulting hydraulic system 22 may be minimized.

Moreover, the load sense signal conditioning passageway 90 that fluidly connects the downstream biasing conduit 82 of each of the implement control systems 17A, 17B translates the response to a pressure fluctuation in one of the implement control systems 17A to the other implement control system 17B, allowing both implement control systems 17A, 17B to react similarly. This may be particularly desirable in an example in which one of the implement control systems (e.g. 17A) operates the left side tread of a work machine 10 and the other of the implement control systems (e.g., 17B) operates the right side tread of the work machine 10. If, during operation, one of the treads were to lose traction on rough ground or due to varied underfoot conditions, the implement control system (e.g., 17A) for that tread could be in a flow-limited condition, resulting in movement of the load compensating valve 36. The movement of the treads would be unbalanced if the load compensating valve 36 in the other implement control system (e.g., 17B) did not move in a proportional manner. Without this movement, the unbalanced movement of the treads could cause the work machine 10 to go off-course—an undesirable condition. The load sense signal conditioning passageway 90 minimizes this condition, however, by affecting a movement in the load compensating valve 36 of the other implement control system 17B, which balances the movement of the two treads.

The load sense signal conditioning passageway 90 in the aspects illustrated in FIGS. 3 and 4 operate similarly to that illustrated in FIG. 2 and described above; the load sense signal conditioning passageway 90 translates the response to a pressure fluctuation on one of the implement control systems (e.g., 17A) to the other implement control system (e.g., 17B), allowing both implement control systems 17A, 17B to react similarly. In this manner, the load sense signal conditioning passageway 90 connects each of the implement control systems and provides for flow sharing between each of the implement control systems/IMV control circuits.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

I claim:

1. A hydraulic system, comprising:
a source of pressurized fluid;
a plurality of fluid actuators having a first chamber and a second chamber, each of the plurality of fluid actuators comprising an implement control system for hydraulically controlling the fluid actuator, each implement control system comprising:
a head-end independent metering (IM) supply valve configured to selectively fluidly connect the source with the first chamber;
a rod-end IM supply valve configured to selectively fluidly connect the source with the second chamber; and
a load compensating valve configured to control a pressure of a fluid directed between the source and the head-end IM supply and rod-end IM supply valves in response to a load acting on the fluid actuator; and
a load sense signal conditioning passageway fluidly connecting each implement control system and configured to facilitate flow sharing between each implement control system.

2. The hydraulic system of claim 1, further comprising an upstream common fluid passageway disposed between the source and the head-end IM supply and rod-end IM supply valves, wherein the head-end IM supply and rod-end IM supply valves are connected to the upstream common fluid passageway in parallel and the load compensating valve is disposed between the upstream common fluid passageway and the source.

3. The hydraulic system of claim 2, further comprising an upstream biasing conduit, wherein the load compensating valve includes a valve element movable between a flow passing position and a flow blocking position, and the upstream biasing conduit is configured to direct fluid from between the source and the load compensating valve to bias the valve element toward one of the flow passing position and the flow blocking position.

4. The hydraulic system of claim 3, further comprising:
a downstream common fluid passageway disposed downstream of the head-end IM supply and rod-end IM supply valves, the head-end IM supply and rod-end IM supply valves fluidly connected with the downstream common fluid passageway; and
an inverse resolver valve disposed within the downstream common fluid passageway between the head-end IM supply and rod-end IM supply valves and movable between a first position where pressurized fluid from the head-end IM supply valve flows through the inverse resolver valve, to a second position where pressurized fluid from the rod-end IM supply valve flows through the inverse resolver valve.

5. The hydraulic system of claim 4, further comprising a downstream biasing conduit configured to direct pressurized fluid from one of the head-end IM supply and rod-end IM supply valves via the inverse resolver valve to the load compensating valve to bias the valve element of the load compensating valve toward the other of the flow passing and flow blocking position.

6. The hydraulic system of claim 1, further comprising:
a tank;
a head-end IM drain valve configured to selectively fluidly connect the tank with the first chamber; and
a rod-end IM drain valve configured to selectively fluidly connect the tank with the second chamber.

7. The hydraulic system of claim 6, wherein each of the head-end IM supply valve, rod-end IM supply valve, head-end IM drain valve, and rod-end IM drain valve are solenoid actuated, hydraulically actuated, mechanically actuated, or pneumatically actuated proportional control valves.

8. The hydraulic system of claim 5, wherein the load sense signal conditioning passageway is fluidly connected to the downstream biasing conduit of each of the implement control systems.

9. The hydraulic system of claim 3, further comprising:
a downstream common fluid passageway disposed downstream of the head-end IM supply and rod-end IM supply valves, the head-end IM supply and rod-end IM supply valves being fluidly connected with the downstream common fluid passageway; and
a resolver disposed within the downstream common fluid passageway between the head-end IM supply and rod-end IM supply valves and movable between a first position where pressurized fluid from the head-end IM supply valve flows through the resolver, to a second position where pressurized fluid from the rod-end IM supply valve flows through the resolver.

10. The hydraulic system of claim 9, further comprising a downstream biasing conduit configured to direct pressurized fluid from one of the head-end IM supply and rod-end IM supply valves via the resolver to the load compensating valve to bias the valve element of the load compensating valve toward the other of the flow passing and flow blocking position,
wherein the load sense signal conditioning passageway is fluidly connected to the downstream biasing conduit of each of implement the control systems.

11. The hydraulic system of claim 3, further comprising a downstream biasing passageway fluidly connected downstream of the load compensating valve and configured to direct pressurized fluid from the load compensating valve to bias the valve element of the load compensating valve toward the other of the flow passing and flow blocking position,
wherein the load sense signal conditioning passageway is fluidly connected to the downstream biasing passageway of each of the implement control systems.

12. A machine, comprising:
a plurality of work implements; and
a hydraulic system, the hydraulic system comprising:
a source of pressurized fluid;
a plurality of fluid actuators, each fluid actuator being associated with a work implement and having a first chamber and a second chamber;
a plurality of implement control systems, each implement control system configured to control one of the fluid actuators and comprising:
a head-end IM supply valve configured to selectively fluidly connect the source with the first chamber;
a rod-end IM supply valve configured to selectively fluidly connect the source with the second chamber; and
a load compensating valve configured to control a pressure of a fluid directed between the source and the head-end IM supply and rod-end IM supply valves in response to a load acting on the fluid actuator; and
a load sense signal conditioning passageway fluidly connecting each implement control system and configured to facilitate flow sharing between each implement control system.

13. The machine of claim 12, further comprising an upstream common fluid passageway disposed between the source and the head-end IM supply and rod-end IM supply valves, wherein the head-end IM supply and rod-end IM supply valves are connected to the upstream common fluid passageway in parallel and the load compensating valve is disposed between the upstream common fluid passageway and the source.

14. The machine of claim 13, further comprising an upstream biasing conduit, wherein the load compensating valve includes a valve element movable between a flow passing position and a flow blocking position, and the upstream biasing conduit is configured to direct fluid from between the source and the load compensating valve to bias the valve element toward one of the flow passing position and the flow blocking position.

15. The machine of claim 14, further comprising:
a downstream common fluid passageway disposed downstream of the head-end IM supply and rod-end IM supply valves, the head-end IM supply and rod-end IM supply valves being fluidly connected with the downstream common fluid passageway; and
an inverse resolver valve disposed within the downstream common fluid passageway between the head-end IM supply and rod-end IM supply valves and movable between a first position where pressurized fluid from the head-end IM supply valve flows through the inverse resolver valve, to a second position where pressurized fluid from the rod-end IM supply valve flows through the inverse resolver valve.

16. The machine of claim 15, further comprising a downstream biasing conduit configured to direct pressurized fluid from one of the head-end IM supply and rod-end IM supply valves via the inverse resolver valve to the load compensating valve to bias the valve element of the load compensating valve toward the other of the flow passing and flow blocking position.

17. The machine of claim 16, wherein the load sense signal conditioning passageway is fluidly connected to the downstream biasing conduit of each of the implement control systems.

18. The machine of claim 14, further comprising:
a downstream common fluid passageway disposed downstream of the head-end IM supply and rod-end IM supply valves, the head-end IM supply and rod-end IM supply valves being fluidly connected with the downstream common fluid passageway; and
a resolver disposed within the downstream common fluid passageway between the head-end IM supply and rod-end IM supply valves and movable between a first position where pressurized fluid from the head-end IM supply valve flows through the resolver, to a second position where pressurized fluid from the rod-end IM supply valve flows through the resolver.

19. A method of operating a first fluid actuator and a second fluid actuator of a hydraulic system comprising:
pressurizing a fluid;
operating the first fluid actuator by:
directing the pressurized fluid to a first chamber of the first fluid actuator via a first head-end IM supply valve;
directing the pressurized fluid to a second chamber of the first fluid actuator via a first rod-end IM supply valve;
selectively operating at least one of the first head-end IM supply and first rod-end IM supply valves to move the first fluid actuator;
moving a valve element of a first load compensating valve in response to pressures upstream and downstream of one of the first head-end IM supply and first rod-end IM supply valves to maintain a pressure differential across the one of the first head-end IM supply and first rod-end IM supply valves;
operating the second fluid actuator by:
directing the pressurized fluid to a first chamber of the second fluid actuator via a second head-end IM supply valve;
directing the pressurized fluid to a second chamber of the second fluid actuator via a second rod-end IM supply valve;
selectively operating at least one of the second head-end IM supply and second rod-end IM supply valves to move the second fluid actuator;
moving a valve element of a second load compensating valve in response to pressures upstream and downstream of one of the second head-end IM supply and second rod-end IM supply valves to maintain a pressure differential across the one of the second head-end IM supply and second rod-end IM supply valves; and
compensating for pressure fluctuations in the first fluid actuator that result in movement of the valve element of the first load compensating valve by moving the valve element of the second load compensating valve.

20. The method of claim 19, wherein compensating for pressure fluctuations in the first fluid actuator comprises directing a pressure signal from the first load compensating valve to the second load compensating valve through a load sense signal conditioning passageway.
